(19) United States
(12) Patent Application Publication
(10) Pub. No.: US 2022/0142382 A1
(43) Pub. Date: May 12, 2022

(54) TABLE AND TRAY ASSEMBLY

(71) Applicant: Torrent, LLC, Boise, ID (US)

(72) Inventor: Brian Bohner, Boise, ID (US)

(21) Appl. No.: 17/522,806

(22) Filed: Nov. 9, 2021

Related U.S. Application Data
(60) Provisional application No. 63/111,386, filed on Nov. 9, 2020.

(51) Int. Cl. A47G 7/04; A47B 7/02; A47B 13/08

(52) U.S. Cl. CPC A47G 7/041; A47B 2200/0001; A47B 13/081; A47B 7/02

(57) ABSTRACT

The invention disclosed herein is directed to a table and tray assembly that can be used for housing plants. The table can be constructed with optional legs. The legs can be foldable and/or removable. The table has a frame that extends the perimeter of the table. The frame has a top flange that is configured to secure a tray in the table. The table has corner brackets that are configured to allow a first table to be securely stacked on a second table. The brackets have a lower vertical flange that engages with an upper flange of a second bracket in stacked form. The tray has a fluid trap and at least one flow channel extending from the fluid trap. The fluid trap has a connection member that can connect the tray to an external fluid source via tubing. The fluid trap can also have an insertable debris trap.

### PRIORITY/CROSS REFERENCE

This application claims priority to U.S. Provisional Patent No. 63/111,386, filed on Nov. 9, 2020, the disclosure of which is incorporated herein by reference.

### TECHNICAL FIELD

The presently disclosed technology relates to table assemblies for use with planters. More particularly, the present invention is directed to a stackable table assembly with a corresponding insertable tray for use with planters.

### BACKGROUND OF THE INVENTION

Many garden centers or nurseries use tables for holding and displaying plants. Planting trays are placed on top of the tables and are generally unsecured on top of the table. The plant trays are generally removed when the tables are moved to prevent the trays from falling off the table or to prevent the contents of the trays from spilling.

Garden centers and nurseries are also generally limited in space. Storing tables typically require stacking the tables on their sides and increasing the stack horizontally. Horizontally stacking the tables reduces the amount of usable space and stacking the tables vertically can be hazardous, especially in a moist environment such as a garden center or nursery, because the tables are prone to sliding off one another and falling to the ground. The risk increases when the tables are stacked higher.

The process of irrigating planters on the tables often results in water accumulating on the table and spilling over in undesired locations or pooling in the trays. Excessive irrigation can also lead to debris from the plant containers spilling over onto the table or onto the floor.

What is needed is a table that is configured for vertical stacking and a tray that can securely attach to the table. What is further needed is a tray having a series of channels to direct water in the tray when a pump fills the tray with water from a water reservoir, and subsequently that directs the water off of the tray and returns it to the reservoir. What is also needed is a debris trap provided on the table at the water return to the tank that can contain the debris that spills from the plant container.

### SUMMARY OF THE INVENTION

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

In accordance with the present invention, a new and improved table and tray assembly is provided which secures plant trays to a table and allows for the tables to stack vertically. The table and tray assembly allows for plants positioned on the tray to be watered from water in the tray, allowing for “bottom up” watering of the plants. The “bottom up” watering configuration prevents the need for water being sprayed on the foliage of plants. It can also reduce evaporation of the water being sprayed from a water source, such as a hose.

In one embodiment, the table and tray assembly has a table that includes a table base and a frame extending around the perimeter of the table. The frame has a flange that extends inwards and downwards from the top edge of the frame. The flange of the frame is designed to engage and secure a tray that has been positioned in the table. The table and tray assembly has at least one stacking feature. The stacking feature is positioned on the frame of the table.

In one embodiment, the stacking feature is a corner bracket positioned on the outer edge of the frame at each corner of the table. The bracket has two flanges, an upper horizontal flange and a lower horizontal flange. Each flange extends a distance inward to match the edge of the table frame. The upper horizontal flange is positioned at the upper edge of the bracket. The upper horizontal flange engages the upper edge of the corner of the table frame.

The lower horizontal flange is positioned at the lower edge of the bracket. The lower horizontal flange engages the lower edge of the corner of the table frame. Extending downward from the lower horizontal flange is a third flange, the vertical flange. The vertical flange can mate with a corner bracket of a second table and tray assembly when the two are in a stacked configuration. The vertical flange in its mated engagement is configured to prevent the movement of the stacked table and tray assemblies.

In alternate embodiments, the upper horizontal flange creates a notch at the upper end of the corner of the table frame. The vertical flange of a second bracket can engage the notch. The engaged vertical flange secures a first table when stacked on a second table.

Alternatively, the stacking feature may be formed as an integral part of the frame of the table. In one embodiment, the frame has an internal rib structure. The frame also has a top flange. The internal rib of a first table is configured to engage the top flange of a second table. In this configuration, the tables are able to stack together. The internal rib acts to secure the tables atop one another.

In a second embodiment of the frame having an integral stacking feature, the frame has an external rib. The frame of this embodiment also has a top flange. The external rib of a first table is configured to engage the top flange of a second table. The external rib acts to secure the tables atop one another.

In some embodiments, the table includes legs extending downward from the table base. The legs can be foldable legs. Alternatively, the legs may be removable from the table.

The table and tray assembly also has a tray that can be inserted into the table frame. The tray has a base, a perimeter wall, a fluid trap, and at least one flow channel formed in the tray base. The fluid trap is formed as part of the tray base, preferably at one end thereof. The fluid trap has a connection member to connect the tray to an external tube. The flow channel extends from the fluid trap parallel to the length of the tray. The flow channel is designed to allow fluid received from the fluid trap to flow through the base of the tray.

In alternate embodiments, there is a plurality of flow channels formed as part of the tray base. Each flow channel extends to and from the fluid trap in a direction parallel to the length of the tray. The plurality of flow channels increases the fluid flowing from the fluid trap and thereby can increase the number of plants being watered.

In one embodiment, the perimeter wall of the tray has at least one notched corner. The notched corner is configured such that the tray can be inserted into the table after construction of the table has been completed. The notched corner also allows for the tray to be removed from the table after construction of the table has been completed.

In yet other embodiments, the fluid trap of the tray can include an insertable debris trap. The debris trap has a plurality of apertures located on the bottom portion thereof. The apertures are configured to allow for the flow of fluid through the debris trap while blocking debris that may washed into it.

In one embodiment, the debris trap has a lid. The lid is configured to support the weight of a plant positioned thereon. In other embodiments, the debris trap may include a sock filter. The sock filter is positioned between the lid and the bottom portion of the debris trap. The sock filter increases the blockage of debris being washed into the debris trap while still allowing fluid to pass through it to the fluid trap.

In another embodiment, the debris trap has at least one support member that protrudes vertically from the debris trap. The support member is designed to support the weight of a plant positioned thereon. In alternate embodiments, the debris trap may include a plurality of support members protruding vertically.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the description of the preferred embodiments is to be regarded as illustrative in nature, and not as restrictive in nature.

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

### BRIEF DESCRIPTION OF DRAWINGS

FIG. 1 is a perspective view of an embodiment of a tray and table assembly.

FIG. 2 is a bottom perspective view of an embodiment of a tray and table assembly stacked on another tray and table assembly.

FIG. 3 is a perspective partial view of an embodiment of a corner bracket of the tray and table assembly relative to a second corner bracket and tray installed in the corner bracket.

FIG. 4 is a top perspective view of an embodiment of a tray.

FIG. 5 is a partial perspective view of an embodiment of a tray.

FIG. 6 is a partial cross sectional view of an embodiment of a tray and table assembly.

FIG. 7 is a perspective view of an embodiment of a debris trap and lid.

FIG. 8 is a perspective view of an embodiment of a debris trap and lid with a sock filter.

FIG. 9 is a perspective view of a table and reservoir.

FIG. 10 is a perspective view of an embodiment of a table having corner protectors and a debris capture basket or strainer.

FIG. 11-12 illustrates a perspective view of an embodiment of a strainer.

FIGS. 13-15 illustrate the interaction between adjacent corner brackets of one embodiment of stacked tables.

FIG. 16 illustrates a perspective view of an embodiment of a frame of the table having an internal rib structure.

FIG. 17 illustrates a perspective view an alternative embodiment of a frame of the table having an external rib structure.

FIG. 18 illustrates a perspective view of an embodiment of two frames of two tables stacked together.

### DETAILED DESCRIPTION OF DRAWINGS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

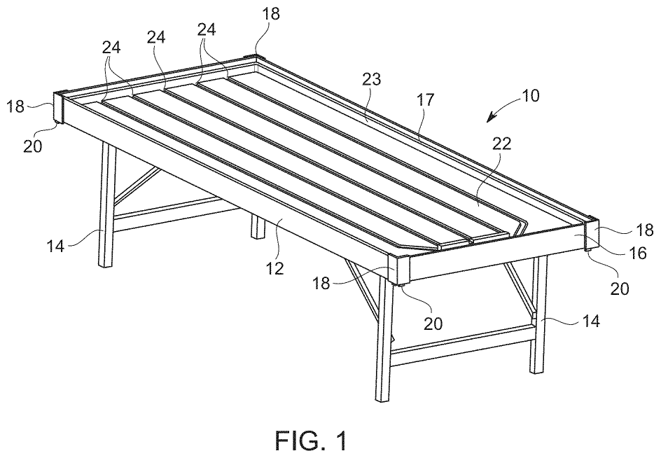

Illustrated in FIG. 1 is one embodiment of a table and tray assembly 10. The table and tray assembly 10 has a table 12 and an insertable tray 22. In the depicted embodiment the table 12 has legs 14. The legs 14 are preferably foldable. In alternate embodiments the legs are removable. Alternatively the table can be constructed without legs. In this embodiment, the table can be set directly onto one or more supporting members, such as concrete blocks or other base material for use. The table 12 has a frame 16 that extends the perimeter of the table 12. The table 12 and frame 16 are preferably made from metal, including but not limited to aluminum, brass, copper, steel, or other metals, including sheet metal and extruded metal. In alternate embodiments, the table and frame can be made from plastic or wood.

The frame 16 of the table 12 has a flange 17 that extends inward and downward towards the center of the table 12. The flange 17 extends the perimeter of the table 12. The flange 17 couples with the perimeter wall 23 of a tray 22, securing the tray 22 onto the table 12. The frame 16 of the table has at least one stacking feature. The stacking feature is configured to secure two tables together when in a stacked configuration.

In the embodiment illustrated in FIG. 1, four corner brackets 18 act as the stacking feature. Each of the four corner brackets 18 are attached to the frame 16 of the table 12. The corner brackets 18 have projections 20 that extend vertical and downward from the base of the table 12. The corner brackets serve to cover any rough edges associated with the corners of the table to prevent injury, for example, to persons handling the tables or inspecting or servicing plants positioned on the tables. The corner brackets 18 are also configured to allow a first table 12 to be stacked on a second table 12 in a secure manner.

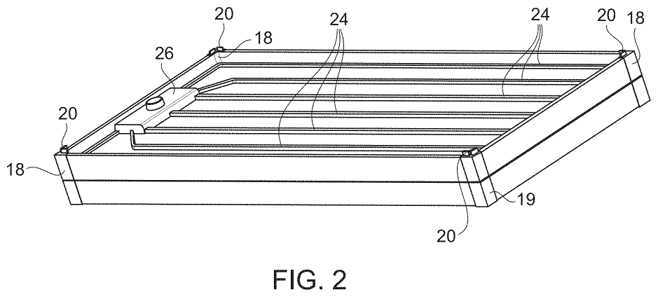

FIG. 2 illustrates a bottom perspective view of an embodiment of two tables stacked together where the stacking feature is the corner brackets. Eight corner brackets (two at each corner) secure the two tables together. Each of the depicted corner brackets 18 attaches to each of the corners of a table 12. The projections 20 of the corner bracket 18 of a first table 12 extend into a corner bracket 18 of a second table 12. The projections 20 are configured for preventing a top table from sliding off a bottom table when the tables are vertically stacked.

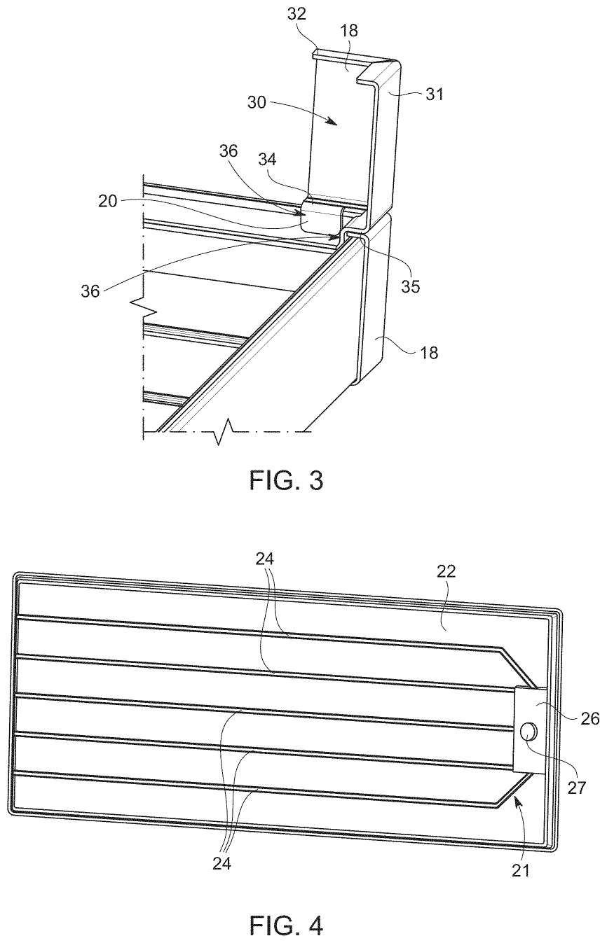

FIG. 3 illustrates a partial perspective view of table 12 having a corner bracket 18 as the stacking feature attached with a second corner bracket 18 in a stacked arrangement. (The upper table is removed to illustrate the upper corner bracket 18.) Each corner bracket 18 has two corner sections 30, 31, that are configured to seat against or proximate to the side walls of the table that form the corner on which the bracket is mounted. The corner bracket has an upper horizontal flange 32 that is configured to be positioned over the outer edge of the corner of the table. The upper flange 32 is configured to prevent vertical movement of the upper table relative to the lower table. The upper flange 32 can be formed either as a unitary piece or split into two or more sections. The two corner sections 30, 31 extend downward from the upper flange 32 and terminate at a lower horizontal flange 34, 35. The lower flange 34, 35 is positioned under a lower edge of the corner of the table. The lower flange 34, 35 is shown having two sections that form a corner that rests on top of the upper flange 32 of the lower bracket 18. Alternatively, the lower flange 34, 35 can be formed as a unitary piece. The lower flange 34, 35 extends to a bottom vertical flange 36. The bottom vertical flange 36 is illustrated having two sections. Alternatively, the bottom vertical flange 36 can be formed as a unitary piece. The bottom vertical flange extends into the cavity of the lower table and serves to prevent horizontal sliding of either table.

FIG. 4 illustrates an embodiment of a tray 22. The tray 22 has at least one flow channel 24. As illustrated, the tray 22 has four flow channels 24. In alternate embodiments, the tray 22 can have more than four flow channels 24, depending on the desired amount of fluid flow needed by the user. The flow channels 24 preferably run parallel to the length of the tray 22. In alternate embodiments, the flow channels can run parallel to the width of the tray or diagonal to the tray body.

The flow channels 24 extend to a fluid trap 26 at the end of the tray 22. The fluid trap 26 allows for the tray to be efficiently filled and drained at one location. The outermost flow channels 24 are configured to angle 21 in towards the fluid trap 26. The fluid trap 26 preferably has a connection member 27 for fluid connection via tubing or piping to a pump (not shown). The pump is connected to one or more fluid holding tanks (reservoirs). Preferably the pump is automated such that it pumps fluid from the holding tank(s) into the table at set times per day. When the pump cycles off, the fluid drains back to the holding tanks, preferably through a filter. Preferably the holding tanks have an automatic valve that maintains the level of fluid in the tanks. The table can optionally be provided with an overflow drain in the event of rain or excess secondary watering of the plants in the tray.

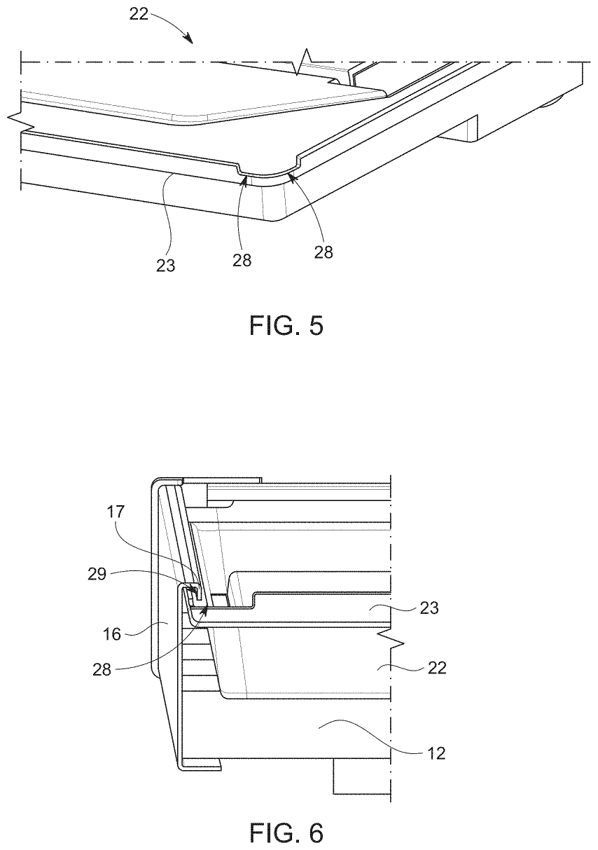

FIG. 5 illustrates a partial perspective view of an embodiment of the tray 22. The tray perimeter wall 23 extends almost entirely the perimeter of the tray 22. The perimeter wall 23 preferably has one notched corner 28. The notched corner 28 is configured to allow for the tray to be inserted into the flange 17 of the table frame 16. The notched corner 28 is configured to allow for the tray 22 to be inserted and/or removed from the table 12 after the table has been completely constructed.

FIG. 6 illustrates a partial view a table 12 and a tray 22 assembled together. The flange 17 of the table frame 16 extends over 29 the perimeter wall 23 of the tray 22. The notched corner 28 allows for tray to insert into the table 12 after the table has been constructed.

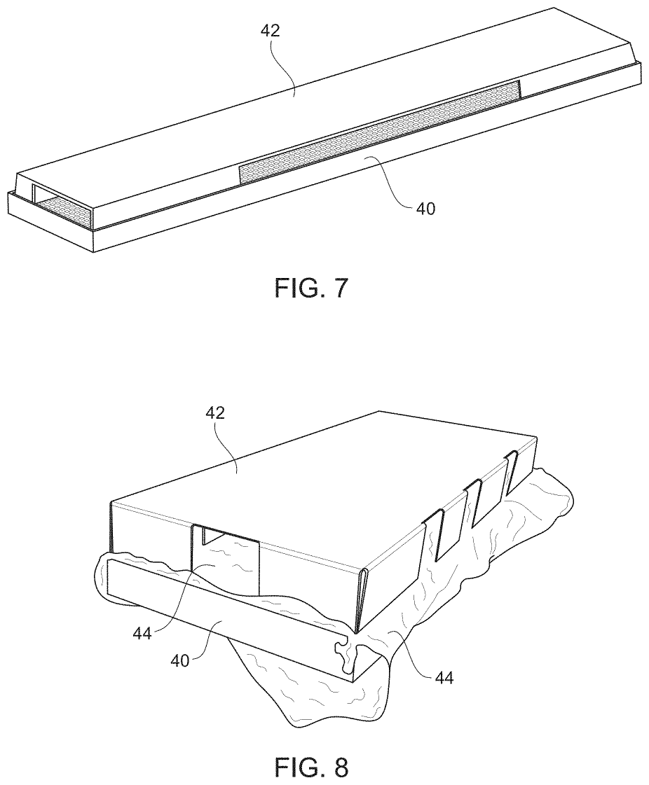

FIG. 7-8 illustrates one embodiment of a debris trap 40. The debris trap 40 has a lid 42 that attaches to the top of the debris trap 40. The lid 42 is configured for supporting the weight of plants positioned on top. FIG. 8 illustrates a sock filter 44 inserted between the lid 42 and debris trap 40. The sock filter 44 is configured for catching small particles of debris that pass through the planters when the planters are irrigated. The debris trap 40 is configured to be positioned in the water trap 26. The debris trap 40 is preferably removable from the water trap 26 to allow for the clearing out of debris.

FIGS. 10-11 illustrates a perspective view of an alternative embodiment of a debris trap. The debris trap 200 illustrated in FIGS. 10-11 has a series of support members 202. The support members 202 are configured to support the weight of plants placed thereon. The debris trap 200 is preferably removable from the water trap 26 to allow for the captured debris to be discarded. The debris trap 200 has a plurality of apertures 204 to allow for fluid to readily flow through. The apertures 204 are preferably of a size to capture the small debris that is released from plants placed on the assembly. The flow channels 24 are configured to lead back into a debris trap. The shape of the flow channels 24 are configured to allow for debris to be easily brushed into a debris trap.

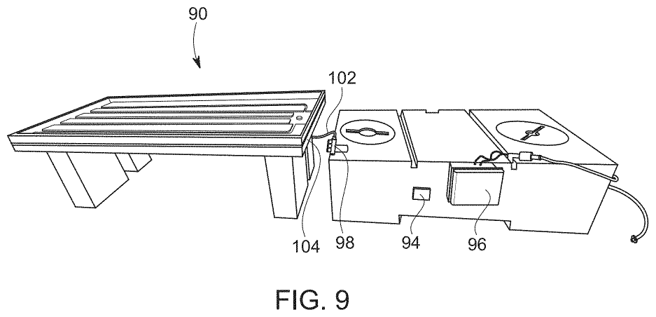

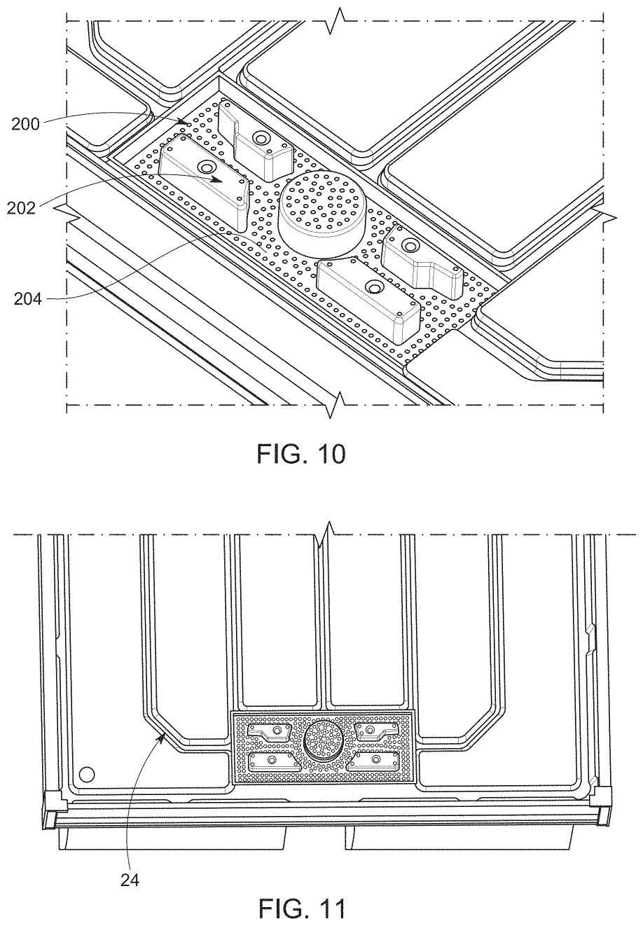

FIG. 9 illustrates a table and tray 90 connected with a reservoir 94. The table is atop three concrete blocks at each corner. The reservoir has a fluid connection (pipe) 102 between a manifold connected to table at an inflow 104. The pump is attached to a valve 98 configured to selectively allow fluid to be pumped from the pump to the table. The valve is controlled by a controller 96.

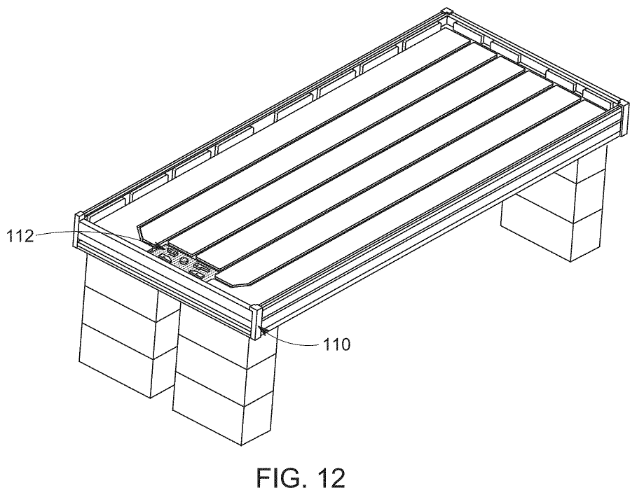

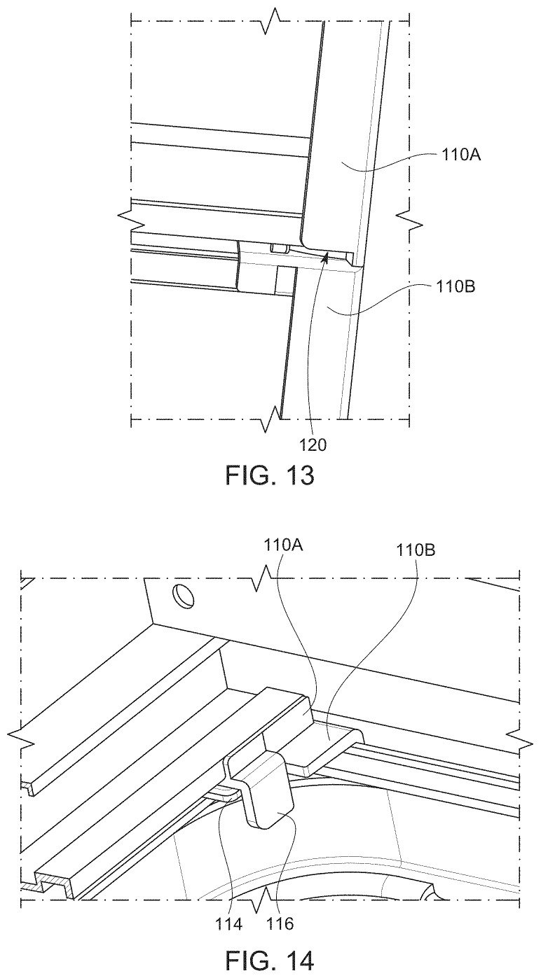

FIG. 12 is a perspective view of an embodiment of a table having optional corner protectors 110 and a debris capture basket or strainer 112. The corner protectors 110 are configured to be integrated with corner brackets 18. FIGS. 13-15 illustrate the interaction between adjacent corner protectors 110 with integrated corner brackets. Corner protector 110A is configured to engage 120 with corner protector 110B. The corner protectors 110 are preferably made from a plastic material. In this stacked engagement, the plastic corner protectors 110 prevent the frame 16 of a table 12 from being scratched when in storage or during shipping.

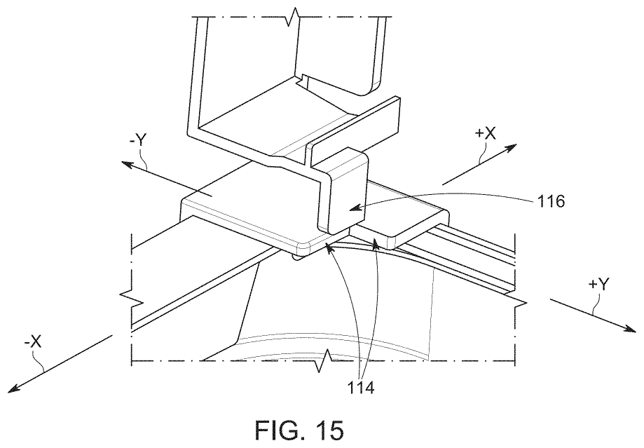

FIG. 14 illustrates a partial perspective view of optional corner protectors 110A, 110B in mating engagement. The corner protector 110A has a lower flange 112. The lower flange 116 is configured to engage a notch 114 of corner protector 110B. FIG. 15 illustrates corner protectors 110A, 110B partially separated from mating engagement. The flange 116 engages the notch 114 such that it is constrained from movement in +X and −Y directions. A stacked table 12 would be constrained from movement in the +Y and −X directions by the corner protectors of each respective corner of a stacked table.

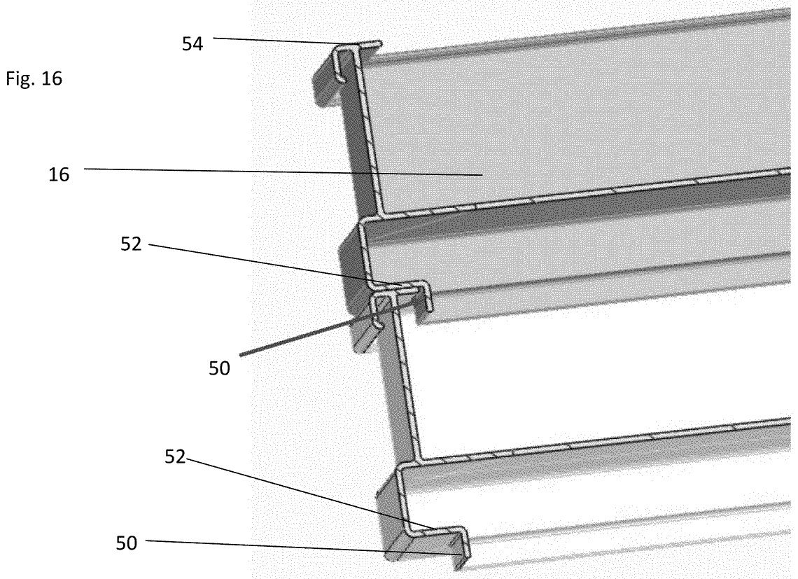

FIG. 16-18 illustrate two embodiments of a frame 16 of the table and tray assembly having an integral stacking feature. FIG. 16 illustrates an embodiment of the frame that has an internal rib 50. The internal rib 50 is positioned at the first end 52 of the frame. The internal rib 50 protrudes inward at the first end 52. The first end 52 is configured to rest on a second end 54 of a second frame when two or more are stacked together. The second end 54 has a flange that protrudes outward. The internal rib 50 is configured to engage the second end 54 of a second frame. The engagement of the internal rib with the second end prevents movement of the table when stacked together.

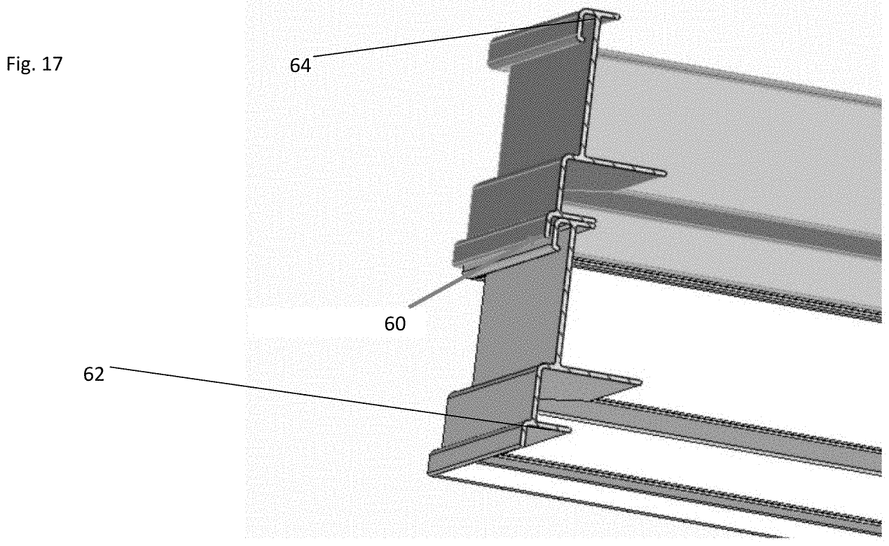

FIG. 17 illustrates an alternative embodiment of a frame having an integral stacking feature. The illustrated embodiment has an external rib 60. The external rib 60 is positioned at the first end 62 of the frame. The external rib 60 protrudes outward from a first end 62. The external rib 60 is configured to engage a second end 64 of a second frame when in a stacked arrangement. The second end 64 has a flange 64 that protrudes outward. The external rib engages the second end to prevent movement of the table when stacked together.

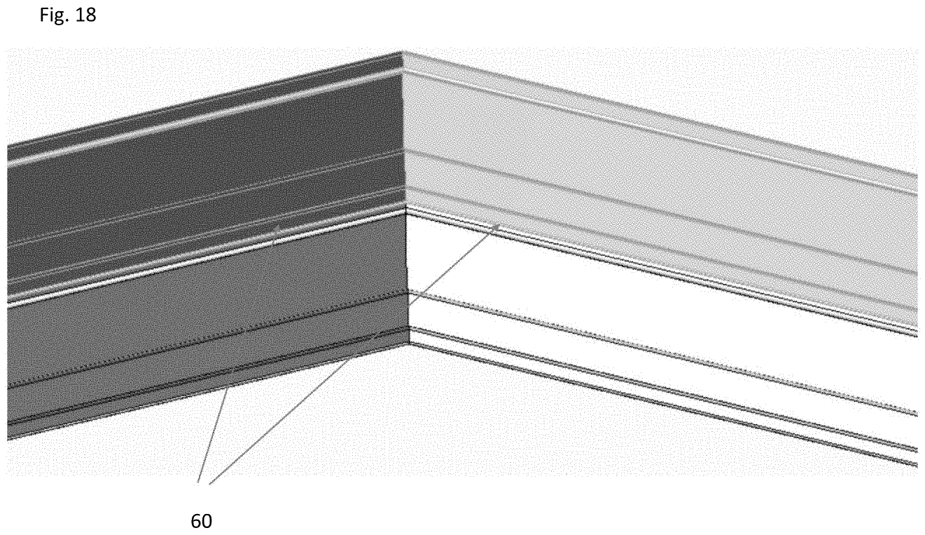

FIG. 18 illustrates a perspective view of two table and assemblies stacked together where the stacking feature is integral to the frame.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

I claim:

1. A table and tray assembly comprising:
a table, wherein said table comprises a table base and a frame, wherein said frame attaches to the perimeter of said table base, wherein said frame comprises a flange that extends around the perimeter of said table, wherein said flange extends inwards and downwards from a top edge of said frame;
a stacking feature attached to said frame of said table; and
a tray, wherein said tray comprises a tray base, a perimeter wall, a fluid trap, and at least one flow channel formed in said tray base and extending from said fluid trap, wherein said flow channel is configured to allow the flow of fluid to and from said fluid trap through said tray base, wherein said fluid trap has a connection member, said connection member configured to attach said fluid trap to an external tube, and wherein said perimeter wall extends the perimeter of said tray base.

2. The table and tray assembly of claim 1 further comprising legs attached to said table base.

3. The table and tray assembly of claim 2 wherein said legs are removable.

4. The table and tray assembly of claim 2 wherein said legs are foldable.

5. The table and tray assembly of claim 1, wherein said fluid trap is configured to receive an insertable debris trap, said debris trap having a plurality of apertures configured to allow fluid to flow through said insertable debris trap and wherein said insertable debris trap is configured for trapping debris flowing through said flow channel to said fluid trap.

6. The table and tray assembly of claim 5, wherein said insertable debris trap has a lid configured for attaching to said debris trap, wherein said lid is configured for supporting the weight of a plant.

7. The table and tray assembly of claim 6, wherein said insertable debris trap further comprises a sock filter, wherein said sock filter is attached between said debris trap and said lid.

8. The table and tray assembly of claim 5, wherein said insertable debris trap has at least one support member protruding vertically from said insertable debris trap and a plurality of apertures, wherein said support member is configured for supporting the weight of a plant, and wherein said apertures are configured to allow fluid to flow through.

9. The table and tray assembly of claim 1, wherein said tray base comprises a plurality of said flow channels.

10. The table and tray assembly of claim 1, wherein said perimeter wall of said tray has at least one notched corner, wherein said notched corner is configured for the insertion of said tray into said frame of said table.

11. The table and tray assembly of claim 1, wherein said upper horizontal flange of said bracket is configured to create a notch at the upper end of said corner of said frame such that said vertical flange engages said notch and is configured to secure a first table and tray assembly stacked on a second table and tray assembly.

12. The table and tray assembly of claim 1, wherein said stacking feature comprises a corner bracket, said corner bracket attaching at a corner of said frame, wherein said corner bracket is configured for vertical stacking of said table and tray assembly, wherein said corner bracket comprises an upper horizontal flange and a lower horizontal flange, wherein said upper horizontal flange is positioned on an upper edge of a corner of said frame, wherein a corner section extends down said corner of said frame to said lower horizontal flange, wherein said lower horizontal flange is positioned at a lower edge of said corner of said frame and extends inward, wherein said lower horizontal flange connects to a vertical flange, wherein said vertical flange extends downward from an end of said lower horizontal flange, and said vertical flange configured for mating engagement with a corner bracket of a second table and tray assembly in a stacked configuration.

13. The table and tray assembly of claim 1, wherein said stacking feature is formed as an integral part to said frame.

14. The table and tray assembly of claim 13, wherein said frame further comprises an internal rib, said internal rib being positioned at a first end of said frame, wherein said internal rib protrudes inward, said frame having a second end wherein said second end has a flange protruding outwards, wherein said internal rib is configured to engage a flange of a second end of a second table and tray assembly in a stacked configuration.

15. The table and tray assembly of claim 13, wherein said frame further comprises an external rib, said external rib being positioned at a first end of said frame, wherein said external rib protrudes outward, said frame having a second end wherein said second end has a flange protruding outwards, wherein said external rib is configured to engage a flange of a second end of a second table and tray assembly in a stacked configuration.
